(19) United States
(12) Patent Application Publication
(10) Pub. No.: US 2010/0096586 A1
(43) Pub. Date: Apr. 22, 2010

(54) NATURAL STUFFING FOR DUVETS/PILLOWS

(75) Inventor: Bonnie Romlund Mikkelsen, Silkeborg (DK)

Correspondence Address: THE NATH LAW GROUP, 112 South West Street, Alexandria, VA, 22314, US

(73) Assignee: SUPREMA DOWN A/S, Lunderskov (DK)

(21) Appl. No.: 12/449,458

(22) PCT Filed: Oct. 5, 2007
(86) PCT No.: PCT/DK2007/000431

§ 371 Date: Dec. 2, 2009

(30) Foreign Application Priority Data
Feb. 9, 2007 (DK) BA200600257

(51) Int. Cl. C09K 3/00

(52) U.S. Cl. 252/182.29

(57) ABSTRACT

A natural duvet/pillow stuffing, which consists of down and feathers with silver particles. The size of said silver particles is ≦5 nm.

### TECHNICAL FIELD

The invention relates to natural duvet/pillow stuffing, which consists of down and feathers with silver particles.

### BACKGROUND

It is well-known that silver has antibacterial properties and that the bacteria do not become resistant to silver. KR 20050016259 also describes adding silver particles to duck feathers for bedclothes in order to provide them with an antibacterial and sterilising effect.

### DISCLOSURE OF THE INVENTION

The aspect of the invention is to provide a natural stuffing for duvets/pillows, said stuffing having a particularly good and stable sterilising effect.

### DETAILED DESCRIPTION OF THE INVENTION

The new aspect of the invention is that the size of the silver particles is ≦5 nanometres.

By this, the natural stuffing is provided with a good, stable and enduring (for several years) antibacterial and sterilising effect and the original “feather smell” is removed together with the smell caused by micro-organisms. Particularly a pronounced smell from mould fungus is removed by this. In addition, the silver enhances the volume of the natural stuffing, in that the volume of the lowest feather qualities is enhanced with up to 10%. The positive charge of the silver ions affects the negative charge of the protein and thus limits static electricity. The silver particles are complete metallic particles and silver ions (Ag+). This size has a particularly good effect against bacteria, which are smaller than viral particles. The effect is enhanced in that silver ions with a size of ≦5 nm will cover a considerably larger surface area than silver ions with a size of e.g. 35 nm, as the former will cover an area of more than 460,000 times its volume, whereas the latter will cover an area of 175,000 times its volume. By this, the surface area for influencing the bacteria will be particularly large. The smaller the silver ions are, the more the fine down strings are prevented from collapsing. The colloid silver shape ensures an efficient distribution of the silver particles on the feathers during the washing process, and especially silver particles of the size in question have a particularly stable ability to maintain the distribution on and the adherence to the down and the feathers for a long time despite many washes, whereby the natural stuffing can maintain its volume without collapsing.

More particularly, it has been found that the silver particles inhibit the presence of Escherichia Coli., Streptococcus pneumoniae, yellow staphylococcus bacteria, and the development of Aspergillus mould fungus. By this, odour problems from bacteria are neutralised, and prevention and/or treatment of mild infections and mucous membrane problems is also observed.

A particularly preferred amount of silver is 1-20 ppm.

Particularly, down and feathers from chickens, ducks, geese, and eider are used for the manufacturing of natural stuffing. An appropriate silver material may be bought in a solution of 1,000 ppm from Shanghai Iluzhong Nano Technology Co. Ltd.

The silver particles are applied during the washing process, where initially the concerned down and feathers are subjected to a raw wash with mainly clean water, potentially added an antibacterial soap. Subsequently, the actual wash with alkaline soap is performed in a controlled manner in order to remove fatty substances. Subsequent to the wash, the feathers and down are rinsed three times with clean water, and the silver material is applied to the third change of rinsing water. After the rinse, the natural stuffing is dried in a tumble dryer. Finally, the natural stuffing is sorted according to quality.

200 kg washed down and feathers rinsed in 120 I water are e.g. added 1,000 ppm silver material.

As mentioned, the silver material in question has a preferred size of ≦5 nm. The amount of silver in the end product is preferably 5 ppm.

1. Natural duvet/pillow stuffing, which consists of down and feathers with silver particles, characterised in that the size of the silver particles is ≦5 nm.

2. Natural stuffing according to claim 1, characterised in that it contains from 1-20 ppm silver.
